(19) United States
(12) Patent Application Publication
(10) Pub. No.: US 2015/0151884 A1
(43) Pub. Date: Jun. 4, 2015

(54) DISPENSER FOR COSMETIC OR PHARMACEUTICAL LIQUIDS

(71) Applicant: APTAR RADOLFZELL GMBH, Radolfzell (DE)

(72) Inventor: Matthias Wochele, Rielasingen-Worblingen (DE)

(21) Appl. No.: 14/417,717

(22) PCT Filed: Jul. 5, 2013
(86) PCT No.: PCT/EP2013/064264

§ 371 Date: Jan. 27, 2015

(30) Foreign Application Priority Data
Aug. 9, 2012 (DE) 10 2012 214 222.3

(51) Int. Cl. B65D 35/08; B65D 35/38; A61J 1/06

(52) U.S. Cl. CPC B65D 35/08; A61J 1/067; B65D 35/38

(57) ABSTRACT

Dispenser for cosmetic or pharmaceutical liquids including a liquid reservoir, in which the liquid is stored prior to a discharge process and which is surrounded by an outer wall, a discharge opening for discharging the liquid into a surrounding atmosphere, and a riser pipe, which extends from the discharge opening into the liquid reservoir.

The outer wall of the liquid reservoir and the riser pipe are formed as a common one-piece component.

### FIELD OF APPLICATION AND PRIOR ART

The invention relates to a dispenser for cosmetic or pharmaceutical liquids, having a liquid reservoir, in which the liquid is stored prior to a discharge process and which is surrounded by an outer wall, having a discharge opening for discharging the liquid into a surrounding atmosphere, and having a riser pipe, which extends from the discharge opening into the liquid reservoir.

Dispensers of this type are known in general. The riser pipes of such designs are used in dispensers with a pump arranged between the riser pipe and discharge opening in order to suck up liquid from a lower region of the liquid reservoir. In the case of dispensers in which the liquid in the liquid reservoir is pressurized, riser pipes are used to be able to push liquid from a lower region of the liquid reservoir into the riser pipe and thus in the direction of the discharge opening.

Dispensers of the type in question are obtainable in many variations on the market. Here, the majority of dispensers are formed from a large number of separate components connected to one another within the scope of an assembly process. In particular, the riser pipe is usually a separate component, which is connected to an application module of the dispenser. However, the construction of a dispenser of the type in question from a plurality of components leads to production costs that are too high in individual cases, moreover depending on the targeted customer group and depending on the market of the product.

### Problem and Solution

The problem addressed by the present invention is therefore that of being able to produce a dispenser of the type in question in a particularly cost-effective manner.

In accordance with the main aspect of the present invention, the outer wall of the liquid reservoir and the riser pipe are formed for this purpose as a common one-piece component.

In accordance with the invention, at least the outer wall surrounding the liquid reservoir and the riser pipe protruding into the liquid reservoir from the side of the discharge opening are thus formed as a component that has been produced in one piece in a common forming process.

Besides the fact that the common production per se saves costs, the one-piece embodiment in which the outer wall and the riser pipe are interconnected on the side of the discharge opening can also spare an assembly process of the riser pipe in practice, which process is sometimes difficult.

The one-piece component, which at least forms the outer wall and the riser pipe, is formed as a plastic component. This is preferably a resiliently deformable plastic with a modulus of elasticity of less than 2 kN/mm². In particular, it may be a polyolefin plastic, in particular LDPE, polyester, PET or TPE.

The riser pipe preferably has a length that accounts for at least 70% of the length of the liquid reservoir in the direction of extension of the riser pipe, such that it reaches into a lower region of the liquid reservoir.

Since in particular a particularly cost-effective dispenser is to be provided, it is considered to be advantageous if the dispenser is formed as a tube dispenser or as a squeeze bottle dispenser and thus has a flexibly deformable outer wall for this purpose. In the case of such a tube dispenser or squeeze bottle dispenser, the discharge process is caused consistently in that the liquid in the liquid reservoir is pressurized by applying pressure directly to the outer wall of the liquid reservoir. Due to this application of pressure, the liquid from the liquid reservoir is pushed into the riser pipe at the distal end thereof with correct orientation and thus reaches the discharge opening.

In the context of this invention, a dispenser in which an initially substantially cylindrical outer wall of the liquid reservoir is closed at the end side during production by end-side compression and welding or adhesive bonding is understood to be a tube dispenser. Such a tube dispenser thus makes it possible to produce a liquid reservoir that is closed at the distal end thereof in a very cost-effective manner, without further components. The end-side welding can be performed by welding in a straight line, implemented transversely to the primary direction of extension of the liquid reservoir. It is particularly preferable if the welding closing the liquid reservoir at the end side has a V shape, such that, when the dispenser is oriented vertically as a whole with discharge opening pointing upwardly, the liquid collects centrally due to the V shape. A particularly extensive discharge of the liquid from the liquid reservoir can thus be attained.

Besides the outer wall of the liquid reservoir and the riser pipe, an applicator portion, in which the discharge opening is provided, is preferably connected integrally to the aforementioned components. A dispenser can thus be produced that is formed of a one-piece component part with regard to all components that are significant for the discharge function of said dispenser. A very low production price can thus be provided. In addition, it is considered to be advantageous if a portion closing the discharge opening in the delivered state is also produced integrally with the applicator portion, wherein this closing portion can preferably be separated by being untwisted from the applicator portion, wherein the discharge opening is opened.

In an embodiment with a riser pipe which from the distal end thereof to the discharge opening defines a closed channel, there is usually merely a discharge of liquid. In such a case, the atomization of the liquid desired depending on the purpose of use is difficult to implement with low production costs of the dispenser, since a swirl chamber necessary for this can be produced only with difficulty without further components. It is therefore particularly advantageous if the riser pipe, in particular at the proximal end thereof facing the discharge opening, has at least one aperture, through which a communicating connection to the liquid reservoir is created.

In such an embodiment a communicating connection between the discharge opening and the liquid reservoir therefore is not provided only by the opening of the riser pipe at the distal end thereof, but additionally by the aforementioned at least one aperture. With intended types of use with upwardly pointing discharge opening, this leads to an actuation of the dispenser formed as a tube dispenser or squeeze bottle dispenser by volume reduction of the liquid reservoir, that on the one hand causes liquid to be pushed into the riser pipe at the distal end and at the other end causes air from the liquid reservoir to be pushed into the riser pipe at the proximal end of the riser pipe. Together, this leads to a swirling of the liquid and thus to the desired spray jet.

A dispenser according to the invention preferably has a volume of the liquid reservoir thereof between 3 ml and 300 ml, in particular between 30 ml and 100 ml. The filled quantity in the delivered state is preferably between 0.1 ml and 250 ml. In the delivered state, at least 20%, in particular between 30% and 70%, of the volume of the liquid reservoir are preferably filled with air in order to enable the above-described production of the spray jet. In order to produce a spray jet, it is also considered advantageous if the riser pipe has a length between 20 mm and 100 mm and/or has a free inner cross section between 0.3 mm² and 2 mm².

The aforementioned apertures at the proximal end of the riser pipe preferably have a cross-sectional area between 0.2 mm² and 2 mm². The discharge opening preferably has a cross-sectional area between 0.1 mm² and 1 mm².

A further advantage that is given from the at at least one proximal aperture of the riser pipe lies in the fact that a two-fold usability of the dispenser is thus attained. In an orientation with upwardly pointing discharge direction, a spray jet can be discharged in the described manner. If, by contrast, the dispenser is brought into an overhead orientation, in which the discharge opening points downwardly, the liquid can thus flow through the aforementioned aperture in the riser pipe into said riser pipe, such that a use of the dispenser as a drop dispenser is possible.

As a secondary aspect of the present invention, the embodiment of a dispenser of the type in question as a tube dispenser with a riser pipe having at least one proximal aperture of the described type is also considered to be particularly advantageous, even if the riser pipe should not be formed in one piece with the outer wall of the liquid reservoir.

In accordance with a further secondary aspect of the present invention, in the case of a dispenser of the type in question and in particular in the case of a dispenser of the described type, the riser pipe has an inner cross section deviating from a circle shape or an ellipsis shape. In particular, it is considered to be advantageous if the riser pipe has an inner cross section which at least in portions has a design characterized by convex indentations. Such convex indentations are understood to mean that sub-regions over the periphery of the inner cross section are inwardly curved, such that the free inner cross section of the riser pipe for example has a star-shaped or cross-shaped design.

This embodiment is therefore advantageous since riser pipes with a very narrow inner diameter can thus be produced, which nevertheless can still be demolded during production.

The need to produce riser pipes having a small inner cross-sectional area is associated with the above-described embodiment in which at least one aperture is provided at the proximal end of the riser pipe in order to produce an atomization. If the inner diameter of the riser pipe is too large, the limited air volume in the liquid reservoir is insufficient to atomize the comparatively large liquid flow. It is therefore desirable to limit the liquid flow, wherein the small inner cross-sectional area at the riser pipe is a proven means for this purpose.

However, if this small inner cross-sectional area is produced with a circular-cylindrical inner cross section, this leads to difficult demolding. An embodiment of the inner cross section in the described form, in particular with the aforementioned convex indentations, leads to considerably facilitated demolding.

### BRIEF DESCRIPTION OF THE DRAWINGS

Further aspects and advantages of the invention, besides from the claims, will also emerge from the following description of a preferred exemplary embodiment of the invention, which is described hereinafter. In the drawings:

FIG. 1 shows a dispenser according to the invention, not in sectional view,

FIG. 2 shows the dispenser of FIG. 1 in a sectional illustration,

FIGS. 2a and 2b shows sections through the riser pipe of the dispenser according to FIGS. 1 and 2 and also an alternative hereto, and

FIGS. 3 and 4 show the use of the dispenser according to FIG. 1 and FIG. 2 in two different orientations.

### DETAILED DESCRIPTION OF THE EXEMPLARY EMBODIMENT

FIG. 1 shows a dispenser 10 according to the invention. This dispenser 10 is formed on the whole in one piece. All of the components of the dispenser, including a closure element 12 intended for removal prior to operation, have been produced for this purpose in a common injection molding method.

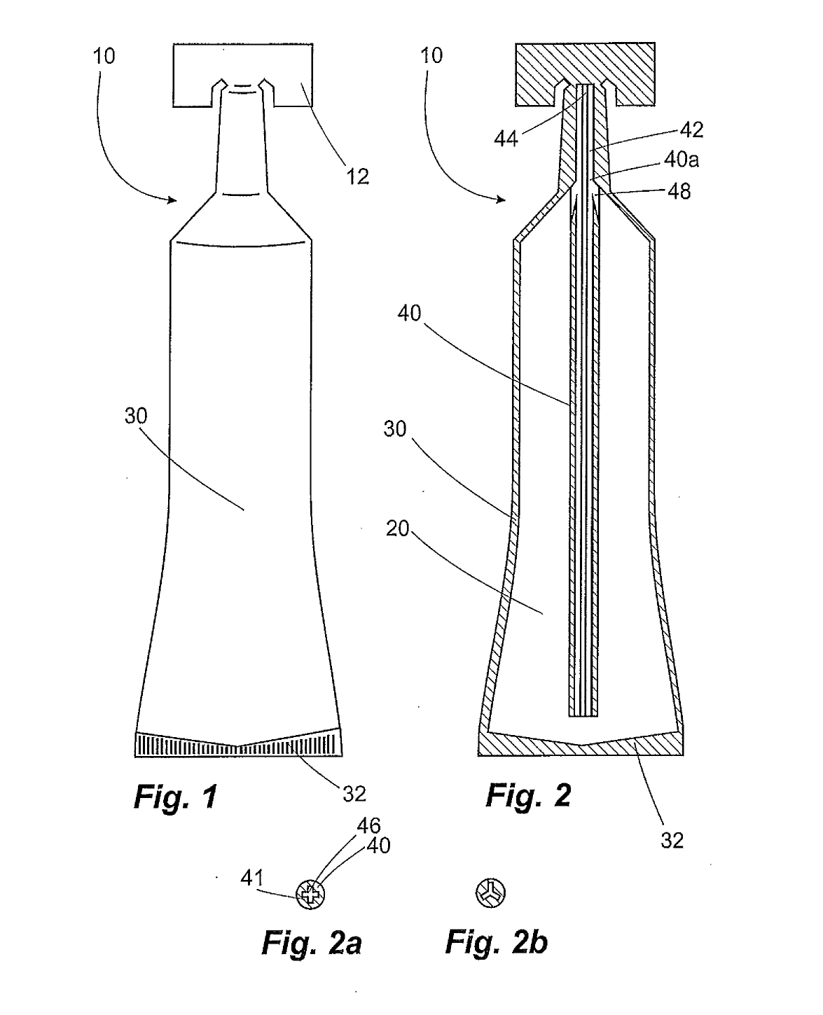

The dispenser comprises, with reference to FIGS. 1 and 2, a liquid reservoir 20, which is surrounded by an outer wall 30. This outer wall 30 is tube-like. It has thus been produced starting from a cylindrical body, which is open at the lower end, by pressing together and welding the lower end 32. The welding is V-shaped here, such that the liquid in the liquid reservoir collects in the middle of the dispenser with an upright orientation.

A riser pipe 40 protrudes into the liquid reservoir 20 and is integrally connected at the upper, proximal end 40a thereof to the upper end of the outer wall 30 of the liquid reservoir 20.

The riser pipe 40 transitions into an outlet channel 42, at the end of which a discharge opening 44 is provided, which is also closed in the state of FIGS. 1 and 2 by the closure portion 12.

The inner cross section 46 of the riser pipe 40 in the manner visible in FIG. 2a has a cross-shaped design. An alternative to this design is illustrated in FIG. 2b. Here, the inner cross section is formed with the design of a three-pronged star. These designs of the inner cross section of the riser pipe 40, which defines the channel to the discharge opening 44, serve the purpose of providing a relatively narrow channel 46. Since, during the injection molding production, this channel has to be kept free by a freeing pin and since it has been found that such a freeing pin tends to bend in the case of a very small inner cross section if it has a circular-cylindrical design, a freeing pin of which the outer contour corresponds to the inner contour according to FIG. 2a or 2b is used when producing the riser pipe 40. Demolding is also facilitated with use of such a pin.

At the proximal end 40a of the riser pipe 40, apertures 48 are provided, by means of which the liquid reservoir 20 is also connected to the discharge channel 42. The purpose of this will be explained hereinafter.

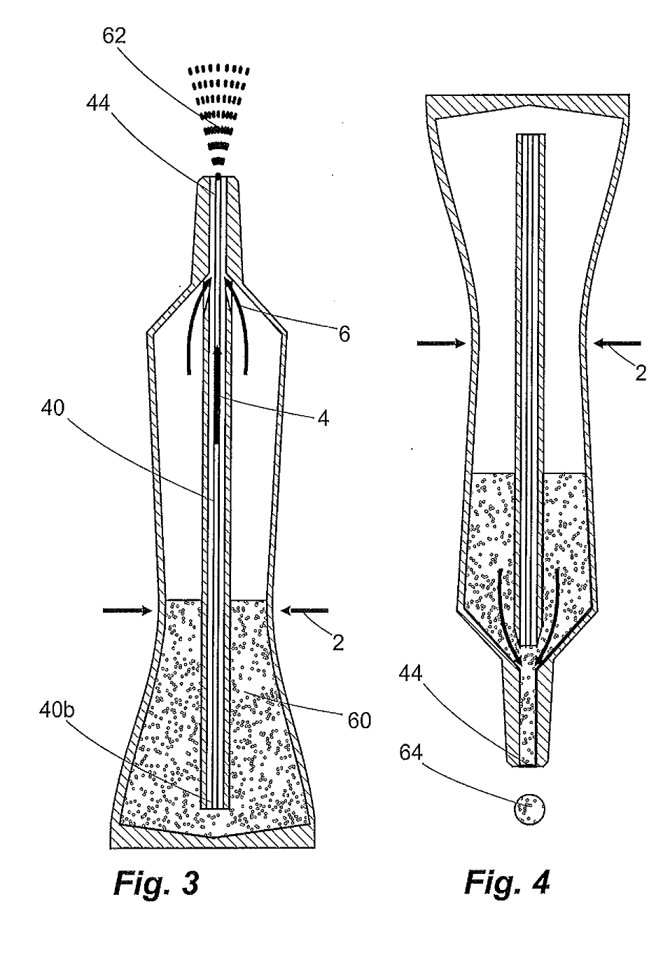

FIGS. 3 and 4 show alternative possibilities for use of the dispenser 10. In the upright position, which is illustrated in FIG. 3, the dispenser is intended for the discharge of a spray jet 62. In this upright position, the liquid collects in the region of the distal end 40b of the riser pipe 40. When, in this state, force is applied in the direction of the arrows 2, liquid is thus pressed through the riser pipe 40 in the direction of the arrow 4. At the same time, air from the upper region of the liquid reservoir is pushed through the apertures 48 in the direction of the arrows 6. This results in a mixing of the air and liquid 60 in the discharge channel 42, which is suitable for producing a spray jet 62 of mixed liquid and air.

The dispenser can additionally also be used in the overhead position illustrated in FIG. 4 with downwardly pointing discharge opening 44. When the dispenser is used in this orientation, the liquid 60 passes through the apertures 48 to the discharge opening 44. Although in principle there is also the possibility with this orientation to produce a discharge jet by a particularly forceful application of force to the outer walls 30, this orientation is intended per se for production of individual drops 64, as indicated in FIG. 4.

The illustrated and described dispenser can be produced easily and cost-effectively. In spite of being formed in one piece, it allows the production of a spray jet 62 and can also be used as a dropper, where appropriate.

1. A dispenser for cosmetic or pharmaceutical liquids, comprising
a liquid reservoir, in which the liquid is stored prior to a discharge process and which is surrounded by an outer wall,
a discharge opening for discharging the liquid into a surrounding atmosphere, and
a riser pipe, which extends from the discharge opening into the liquid reservoir,
wherein
the outer wall of the liquid reservoir and the riser pipe are formed as a common one-piece component.

2. The dispenser as claimed in claim 1,
wherein
the dispenser is formed as a tube dispenser or squeeze bottle dispenser with a flexibly deformable outer wall of the liquid reservoir for the purpose of the discharge.

3. The dispenser as claimed in claim 1,
wherein
the discharge opening is provided in an applicator portion, which is formed in one piece with the outer wall of the liquid reservoir and the riser pipe.

4. The dispenser according to claim 1,
wherein
the riser pipe, at the proximal end thereof facing the discharge opening, has apertures, by means of which a communicating connection to the liquid reservoir is created.

5. The dispenser as claimed in claim 1,
wherein
the dispenser is formed as a tube dispenser and
the riser pipe, at the proximal end thereof facing the discharge opening, has apertures, by means of which a communicating connection to the liquid reservoir is created.

6. The dispenser as claimed in claim 1,
wherein
the riser pipe has an inner cross section deviating from a circle shape or an ellipsis shape.

7. The dispenser as claimed in claim 6,
wherein
the riser pipe has an inner cross section, which at least in portions has a design with convex indentations.

8. The dispenser as claimed in claim 6,
wherein
the riser pipe has a star-shaped or cross-shaped cross section, in particular in the form of a three-pronged star.

9. A dispenser for cosmetic or pharmaceutical liquids, comprising
a liquid reservoir, in which the liquid is stored prior to a discharge process and which is surrounded by an outer wall,
a discharge opening for discharging the liquid into a surrounding atmosphere, and
a riser pipe, which extends from the discharge opening into the liquid reservoir,
wherein
the dispenser is formed as a tube dispenser, and
the riser pipe, at the proximal end thereof facing the discharge opening, has apertures by means of which a communicating connection to the liquid reservoir is created.

10. A dispenser for cosmetic or pharmaceutical liquids, comprising
a liquid reservoir, in which the liquid is stored prior to a discharge process and which is surrounded by an outer wall,
a discharge opening for discharging the liquid into a surrounding atmosphere, and
a riser pipe, which extends from the discharge opening into the liquid reservoir,
wherein
the riser pipe has an inner cross section deviating from a circle shape or an ellipsis shape.

11. The dispenser as claimed in claim 10,
wherein
the riser pipe has an inner cross section which at least in portions has a design with convex indentations.

12. The dispenser as claimed in claim 10,
wherein
the riser pipe has a star-shaped or cross-shaped cross section, in particular in the form of a three-pronged star.
